(19) United States
(12) Patent Application Publication
(10) Pub. No.: US 2024/0104379 A1
(43) Pub. Date: Mar. 28, 2024

(54) AGENT CONTROL THROUGH IN-CONTEXT REINFORCEMENT LEARNING

(71) Applicant: DeepMind Technologies Limited, London (GB)

(72) Inventors: Michael Laskin, New York, NY (US); Volodymyr Mnih, Toronto (CA); Luyu Wang, Oakville (CA); Satinder Singh Baveja, Ann Arbor, MI (US)

(21) Appl. No.: 18/477,492

(22) Filed: Sep. 28, 2023

Related U.S. Application Data
(60) Provisional application No. 63/411,089, filed on Sep. 28, 2022.

(51) Int. Cl. G06N 3/08

(52) U.S. Cl. CPC G06N 3/08

(57) ABSTRACT

Methods, systems, and apparatus, including computer programs encoded on a computer storage medium, for controlling agents. In particular, an agent can be controlled using an action selection neural network that performs in-context reinforcement learning when controlling an agent on a new task.

### CROSS-REFERENCE TO RELATED APPLICATION

This application claims priority to U.S. Provisional Application No. 63/411,089, filed on Sep. 28, 2022. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that controls an agent interacting with an environment to perform a task in the environment using an action selection neural network.

More specifically, the agent selection neural network represents an “in-context” reinforcement learning algorithm. That is, by virtue of being conditioned on context data from previous interactions with the environment while the agent was controlled using the action selection neural network, as the amount of context data increases the action selection neural network can select actions that result in improved performance on the task (relative to earlier time points during the agent control) without updating the parameters of the action selection neural network. In other words, the action selection neural network can “mimic” the performance of a reinforcement learning algorithm as the amount of available data increases without needing to update the parameters of the neural network, i.e., without needing to further train the neural network.

Particular embodiments of the subject matter described in this specification can be implemented so as to realize one or more of the following advantages.

This specification describes an action selection neural network that can be used to perform in-context reinforcement learning on a new task after being trained on a training data set. When performing the new task, the action selection neural network can be significantly more data efficient than the reinforcement learning algorithm(s) that were used to generate the training data set, e.g., because a multi-actor algorithm is “distilled” into a single actor algorithm, because the system subsampled training episodes when generating the training data set, or both.

Moreover, “learning” a new task using the action selection neural network also consumes significantly fewer computational resources than using an RL algorithm to learn a policy for the new task because no computationally expensive backward passes are required due to the action selection neural network no longer needing to be updated during the “learning.” That is, because the action selection neural network improves on a new task solely by observing more context and without updating the weights of the neural network, no gradient computations and, therefore, no backward passes are necessary while still improving performance on the new task.

Additionally, distributed reinforcement learning algorithms require a large amount of network communication between distributed actors and learners during the learning process. This network communication is greatly reduced or even entirely eliminated by making use of the already-trained action selection neural network. That is, by making use of the described “in-context” reinforcement learning scheme, the system can achieve, with a single actor implemented on a single set of one or more hardware devices, performance on a given new task that is comparable to or better than when the task is learned using a distributed reinforcement learning algorithm that requires multiple actors and one or more learners each implemented on a different set of one or more hardware devices. Thus, network communication is greatly reduced because no weight updates need to be transmitted between the actors and the learners and no transitions a required to be sampled from a replay buffer.

Additionally, after training and when “in-context learning” a new task, storage requirements are at least comparable to and, in many cases, even significantly reduced relative to distributed reinforcement learning algorithms because only the tokenized observations, actions, and rewards that are required for the current context to the action selection neural network at the current time step are required to be stored and any tokenized observations and rewards that are no longer needed for the context can be discarded. Distributed reinforcement learning algorithms, on the other hand, are required to maintain a replay buffer that includes a large number of transitions that the learner can sample from to train the neural network. By removing the requirement to maintain this large replay buffer, the described techniques greatly reduce the storage requirements of “learning” a new task.

Moreover, the action selection neural network can be trained purely “offline,” i.e., without needing to be used to control the agent. This avoids damage or wear-and-tear to real-world agents as well affording the ability to amortize and parallelize the training workloads.

Moreover, once trained, the same action selection neural network can be used to “learn” many new tasks without needing any further training, greatly reducing the amount of computational resources required within a multi-task system.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 is a flow diagram of an example process for training the action selection neural network.

FIG. 3 is a flow diagram of an example process for generating a training history sequence for a given task.

FIG. 4 is a diagram of an example of training the action selection neural network.

FIG. 5 is a flow diagram of an example process for controlling an agent using the action selection neural network.

FIG. 6 shows an example of attention maps generated by the action selection neural network.

FIG. 7 shows the performance of the described techniques relative to baseline techniques. Like reference numbers and designations in the various drawings indicate like elements.

### DETAILED DESCRIPTION

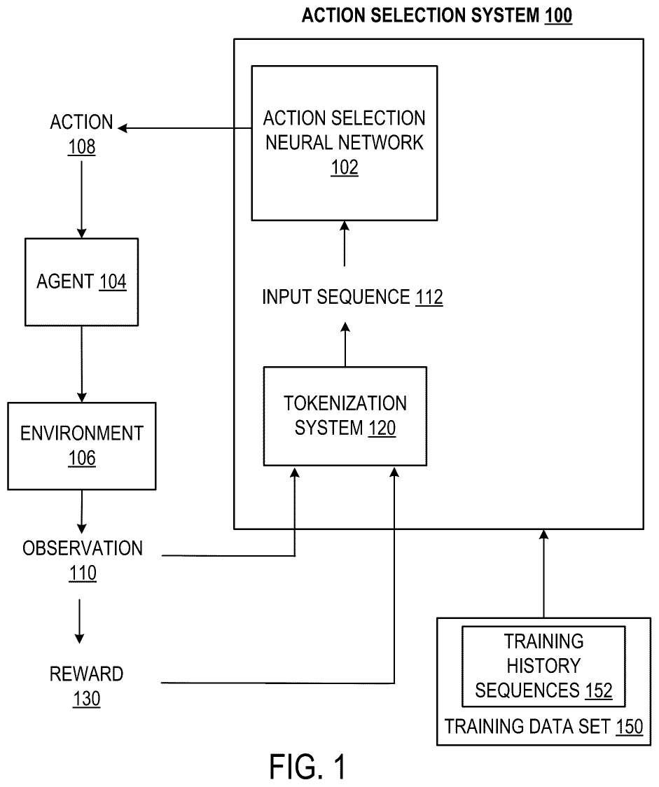

FIG. 1 shows an example action selection system 100. The action selection system 100 is an example of a system implemented as computer programs on one or more computers in one or more locations in which the systems, components, and techniques described below are implemented.

The action selection system 100 controls an agent 104 interacting with an environment 106 to accomplish a task by selecting actions 108 to be performed by the agent 104 at each of multiple time steps during the performance of an episode of the task.

As a general example, the task can include one or more of, e.g., navigating to a specified location in the environment, identifying a specific object in the environment, manipulating the specific object in a specified way, controlling items of equipment to satisfy criteria, distributing resources across devices, and so on. More generally, the task is specified by received rewards, i.e., such that an episodic return is maximized when the task is successfully completed. Rewards and returns will be described in more detail below. Examples of agents, tasks, and environments are also provided below.

An “episode” of a task is a sequence of interactions during which the agent attempts to perform a single instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

At each time step during any given task episode, the system 100 receives an observation 110 characterizing the current state of the environment 106 at the time step and, in response, selects an action 108 to be performed by the agent 104 at the time step. After the agent performs the action 108, the environment 106 transitions into a new state and the system 100 receives a reward 130 from the environment 106.

Generally, the reward 130 is a scalar numerical value and characterizes the progress of the agent 104 towards completing the task.

As a particular example, the reward 130 can be a sparse binary reward that is zero unless the task is successfully completed as a result of the action being performed, i.e., is only non-zero, e.g., equal to one, if the task is successfully completed as a result of the action performed.

As another particular example, the reward 130 can be a dense reward that measures a progress of the agent towards completing the task as of individual observations received during the episode of attempting to perform the task, i.e., so that non-zero rewards can be and frequently are received before the task is successfully completed.

While performing any given task episode, the system 100 selects actions in order to attempt to maximize a return that is received over the course of the task episode.

That is, at each time step during the episode, the system 100 selects actions that attempt to maximize the return that will be received for the remainder of the task episode starting from the time step.

Generally, at any given time step, the return that will be received is a combination of the rewards that will be received at time steps that are after the given time step in the episode.

For example, at a time step t, the return can satisfy:

Σᵢγ^{i-t-1}rᵢ,

where i ranges either over all of the time steps after t in the episode or for some fixed number of time steps after t within the episode, γ is a discount factor that is greater than zero and less than or equal to one, and rᵢ is the reward at time step i.

To control the agent, at each time step in the episode, an action selection subsystem 102 of the system 100 uses an action selection neural network 102 to select the action 108 that will be performed by the agent 104 at the time step.

At a high-level, the system 100 generates an input sequence 112 from the observation 110 and then processes the input sequence 112 using the action selection neural network 102 to generate a policy output for the time step.

As will be described in more detail below, the input sequence 112 generally represents the observation 110 and additionally includes context data from previous time steps within the current episode and within previous episodes of performing the task.

The system then selects the action 108 using the policy output and causes the agent 104 to perform the selected action 108.

More specifically, the agent selection neural network 102 represents an “in-context” reinforcement learning algorithm.

That is, by virtue of being conditioned on context data from previous interactions with the environment while the agent 104 was controlled using the action selection neural network 102 and as the amount of available context data increases, the action selection neural network 102 can select actions that result in improved performance on the task (relative to earlier time points during the agent control) without updating the (learnable) parameters, e.g., weights, of the action selection neural network 102.

In other words, the action selection neural network 102 can “mimic” the performance of a reinforcement learning algorithm as the amount of available data increases without needing to update the parameters of the neural network 102, i.e., without needing to further train the neural network.

In particular, the system 100 trains the action selection neural network 102 and then, after training, uses the action selection neural network 120 as an “in-context” reinforcement learning algorithm while performing new tasks, i.e., performs new tasks without needing to further train the action selection neural network 102.

For each new task, the performance, e.g., in terms of the average return obtained during any given task episode, of the action selection neural network 102 in controlling the agent on the task improves as the amount of available context data increases and without needing to train the action selection neural network 102.

To train the action selection neural network 102, the system obtains a training data set 150 that includes a respective training history sequence 152 for each of a plurality of tasks.

Generally, each training history sequence 152 includes a sequence of tokens that represents transitions from a plurality of task episodes that were performed while training a policy, in particular an action selection policy, for the task through reinforcement learning. The policy for the task can be any appropriate policy, e.g., any appropriate policy that can be adjusted through training in order to improve the performance of the policy on the task, and can be represented by a neural network or other machine learning model with the same architecture as the neural network 102 or a different architecture from the neural network 102. That is, any appropriate training history sequence 152 for the training of any appropriate policy can be incorporated into the training data set 150. In general an action selection policy can be a mechanism for selecting an action in response to an observation (of an environment).

As described above, an “episode” of a task (or a “task episode”) is a sequence of interactions during which the agent attempts to perform an instance of the task starting from some starting state of the environment.

In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task. At each time step in the task episode, the agent receives an observation characterizing the state of the environment as of the time step, performs an action in response to the observation, and receives a reward.

In other words, the task episode results in a sequence of “transitions” that each correspond to a different time step and that each include a respective observation, a respective action, and a respective reward that was received in response to the action being performed.

The sequence of tokens in a training history sequence 152 includes a respective episode subsequence for each the plurality of task episodes that occurred during the training of the policy for the task.

The respective episode subsequence for each of the task episodes includes, for each transition from the task episode, a respective transition subsequence that includes, (i) one or more tokens representing an observation in the transition, (ii) one or more tokens representing an action in the transition, and (iii) one or more tokens representing a reward in the transition.

A “token” as used in this specification is a vector of numerical values having a specified dimensionality.

In other words, a tokenization system 120 within the system 100 or a different tokenization system pre-processes the observations, actions, and rewards to “tokenize” them so that each observation, action, and reward is represented as one or more tokens each having a predetermined dimensionality.

The system 120 can represent observations, actions, and rewards as tokens in any appropriate way.

One example technique for doing so is described in Lili Chen, Kevin Lu, Aravind Rajeswaran, Kimin Lee, Aditya Grover, Misha Laskin, Pieter Abbeel, Aravind Srinivas, and Igor Mordatch. Decision transformer: Reinforcement learning via sequence modeling. Advances in neural information processing systems, 34:15084-15097, 2021.

Another example technique for doing so is described in Scott Reed, Konrad Zolna, Emilio Parisotto, Sergio Gomez Colmenarejo, Alexander Novikov, Gabriel Barth-Maron, Mai Gimenez, Yury Sulsky, Jackie Kay, Jost Tobias Springenberg, Tom Eccles, Jake Bruce, Ali Razavi, Ashley Edwards, Nicolas Heess, Yutian Chen, Raia Hadsell, Oriol Vinyals, Mahyar Bordbar, and Nando de Freitas. A Generalist Agent, 2022, arXiv:2205.06175.

That is, the system 120 can use one of the above techniques or another technique to represent any given received action, observation, and reward as a respective set of one or more tokens having the predetermined dimensionality.

The system 120 can generally use the same tokenization technique when generating the data in the training sequence and when generating the input sequence 112 that is processed by the action selection neural network 102 after training.

The system 100 then trains the action selection neural network 102 on the training data set. The result of the training is that the action selection neural network 102 is able to perform the “in-context” reinforcement learning described above and below.

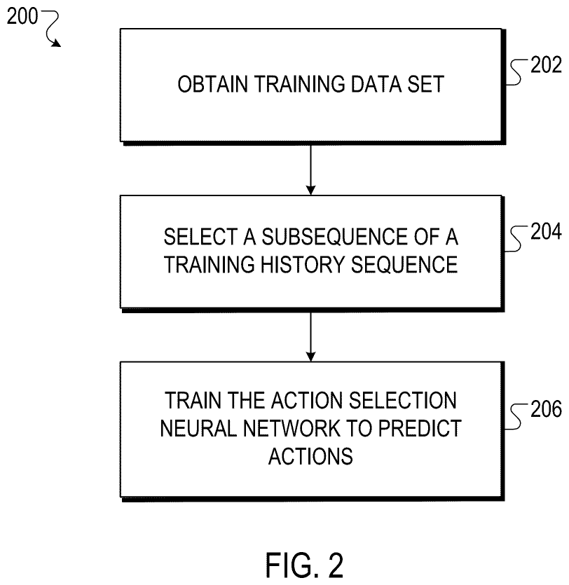

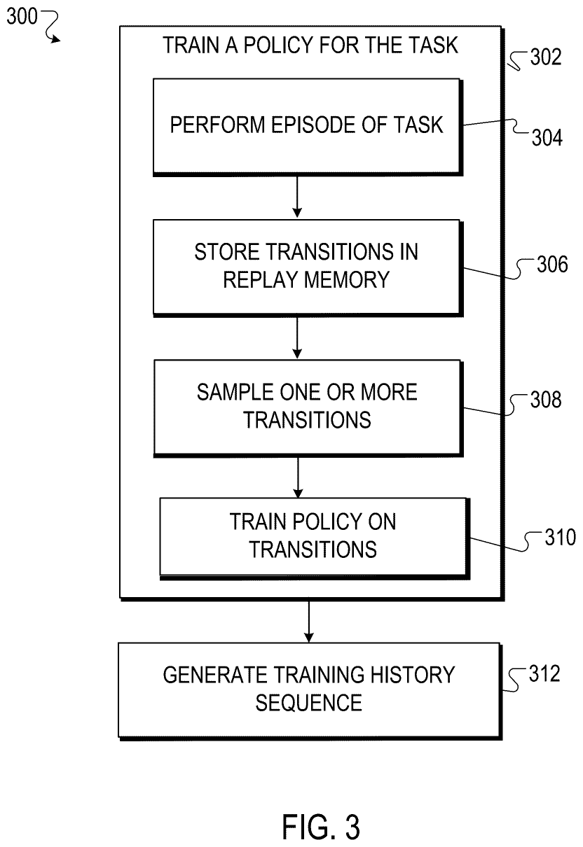

This training is described in more detail below with reference to FIGS. 2 and 3.

After the training, the system 100 can control the agent 104 to perform a task by controlling the agent 104 using the action selection neural network 102 at each of a plurality of time steps in a sequence of time steps in a “current” task episode.

At each time step, the system 100 receives a current observation 110 characterizing a state of the environment 106 at the time step.

The tokenization system 120 then generates an input sequence 112 of tokens.

The input sequence 112 generally includes: (i) one or more tokens representing the current observation 110, (ii) a respective current transition subsequence for each of one or more current episode transitions and (iii) a respective previous transition subsequence for each of one or more previous episode transitions.

In some cases, the tokens in the input sequence 112 other than the one or more tokens representing the current observation 110 have already been generated and the tokenization system 120 only needs to tokenize the current observation 110 to generate the one or more tokens representing the current observation 110.

Each current episode transition corresponds to a respective earlier time step in the current task episode and the respective transition subsequence for the current episode transition includes (a) one or more tokens representing an observation received at the earlier time step, (b) one or more tokens representing an action that was performed by the agent in response to the observation received at the earlier time step, and (c) one or more tokens representing a reward that was received in response to the agent performing the action.

Each previous episode transition corresponds to a respective earlier time step in a respective previous task episode (of the current task) that was performed by the agent prior to the current task episode and the respective previous transition subsequence for the previous episode transition includes (a) one or more tokens representing an observation received at the earlier time step, (b) one or more tokens representing an action that was performed by the agent in response to the observation received at the earlier time step, and (c) one or more tokens representing a reward that was received in response to the agent performing the action.

That is, the input sequence 112 provides context from earlier in the current episode and also from preceding task episodes.

As described above, the system 100 then processes the input sequence 112 of tokens using the action selection neural network to generate a policy output for the time step, selects an action using the policy output; and causes the agent to perform the selected action.

The policy output can be any appropriate output that defines a probability distribution over the set of actions. For example, the policy output can include a respective probability for each action in the set of actions. As another example the policy output can include the parameters of the probability distribution over the set of actions.

The system 100 can select the action 108 by, e.g., selecting the action with the highest probability according to the probability output or sampling an action from the probability distribution defined by the policy output.

The action selection neural network 102 can be any appropriate sequence model, e.g., can have any appropriate architecture that allows the neural network 102 to map an input sequence of tokens to a probability distribution.

As one example, the action selection neural network 102 can be a causal Transformer neural network, i.e., a neural network that includes one or more causally masked self-attention layers, e.g., so that at each time step the self-attention neural network layers see only past inputs in a sequence of processed inputs. A self-attention layer can be one that maps a query and a set of key-value pairs, each derived from an input to the self-attention layer (e.g., all vectors), to an output from which an output of the self-attention layer is derived. The output can be computed as a weighted sum of the values, weighted by a similarity function of the query to each respective key.

When the action selection neural network 102 is a causal Transformer, “processing” the input sequence 112 can refer to either processing the entire sequence to recompute hidden states for earlier tokens in the sequence, accessing cached hidden states from memory and only computing hidden states for the last token in the sequence, or making use of any other techniques to lengthen the context window of attention, to decrease inference latency, or both.

As another example, the action selection neural network 102 can be a recurrent neural network (RNN), i.e., a neural network that includes one or more recurrent neural network layers. For example, the neural network 102 can be a long short-term memory (LSTM) neural network or a gated recurrent unit (GRU) neural network.

When the action selection neural network 102 is a recurrent neural network, “processing” the input sequence 112 can refer to processing the entire sequence to recompute hidden states for earlier tokens in the sequence or accessing the most recently updated hidden states from memory and only updating the hidden states by processing the last token in the sequence.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation, e.g., steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing environment may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g., minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general the actions may be any actions that have an effect on the observed state of the environment, e.g., actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g., sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g., data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment. The task may comprise a task to control, e.g., minimize, use of a resource, such as a task to control electrical power consumption, or water consumption. The agent may comprise an electronic agent configured to control operation of the items of equipment, or to control operation of the ancillary, e.g., environmental, control equipment.

In general the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g., minimize, use of a resource, such as a task to control use of electrical power or water, the metric may comprise any metric of use of the resource.

In some implementations the environment is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that indirectly performs or controls the protein folding actions or chemical synthesis steps, e.g., by controlling synthesis steps selected by the system automatically without human interaction. The observations may comprise direct or indirect observations of a state of the protein or chemical/intermediates/precursors and/or may be derived from simulation. Thus the system may be used to automatically synthesize a protein with a particular function such as having a binding site shape, e.g., a ligand that binds with sufficient affinity for a biological effect that it can be used as a drug. For example, e.g., it may be an agonist or antagonist of a receptor or enzyme; or it may be an antibody configured to bind to an antibody target such as a virus coat protein, or a protein expressed on a cancer cell, e.g., to act as an agonist for a particular receptor or to prevent binding of another ligand and hence prevent activation of a relevant biological pathway.

In a similar way the environment may be a drug design environment such that each state is a respective state of a potential pharmaceutical drug and the agent is a computer system for determining elements of the pharmaceutical drug and/or a synthetic pathway for the pharmaceutical drug. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources, e.g., on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g., an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e., observations of a mechanical shape or of an electrical, mechanical, or electro-mechanical configuration of the entity, or observations of parameters or properties of the entity. The actions may comprise actions that modify the entity, e.g., that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus a design of an entity may be optimized, e.g., by reinforcement learning, and then the optimized design output for manufacturing the entity, e.g., as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

FIG. 2 is a flow diagram of an example process 200 for training the action selection neural network. For convenience, the process 200 will be described as being performed by a system of one or more computers located in one or more locations. For example, an action selection system, e.g., the action selection system 100 of FIG. 1, appropriately programmed in accordance with this specification, can perform the process 200.

The system obtains a training data set that includes a respective training history sequence for each of a plurality of tasks (step 202).

A training history sequence for a given task includes a sequence of tokens that represents transitions from a plurality of task episodes that were performed while training a policy for the task through reinforcement learning.

In other words, each training history sequence includes transitions generated while an agent for the task was being controlled by the policy for the task at multiple different time points during the training of the policy.

Generally, the sequence of tokens in the training history sequence includes a respective episode subsequence for each of the plurality of task episodes and the respective episode subsequence for each of the task episodes includes, for each transition from the task episode, a respective transition subsequence.

Each transition subsequence, in turn, includes (i) one or more tokens representing an observation in the transition, (ii) one or more tokens representing an action in the transition, and (iii) one or more tokens representing a reward in the transition.

Thus, when there are N total tasks M n, the data set D can be represented as:

D:={(o₀⁽ⁿ⁾,α₀⁽ⁿ⁾,r₀⁽ⁿ⁾, . . . ,o_{T}⁽ⁿ⁾,α_{T}⁽ⁿ⁾,r_{T}⁽ⁿ⁾)˜P_{M}_{ₙ}^{source}}ₙ₌₁^{N},

where (o₀⁽ⁿ⁾, α₀⁽ⁿ⁾, r₀⁽ⁿ⁾, . . . , o_{T}⁽ⁿ⁾, α_{T}⁽ⁿ⁾, r_{T}⁽ⁿ⁾)) is the sequence of tokens in the training history sequence for task Mₙ, oₜ⁽ⁿ⁾ is the one or more tokens representing an observation received at time step t when training on task Mₙ, oₜ⁽ⁿ⁾ is the one or more tokens representing the action performed at time step t when training on task Mₙ, rₜ⁽ⁿ⁾ is the one or more tokens representing the reward received in response to performing the action at time step t when training on task Mₙ, t ranges from 0 to T, T is the total number of time steps in the training history sequence for task Mₙ, and P_{M}_{ₙ}^{source} the reinforcement learning algorithm used to train the policy to perform the task Mₙ.

Generally, within each training history sequence, the episode subsequences are ordered according to an order in which the corresponding task episodes were performed during the training. Thus, in the above, a transition subsequence o_{T}⁽ⁿ⁾, α_{T}⁽ⁿ⁾, r_{T}⁽ⁿ⁾ occurred during a task episode that was performed last during the training and the transition subsequence o₀⁽ⁿ⁾,α₀⁽ⁿ⁾, r₀⁽ⁿ⁾ occurred first during the training.

Additionally, for any given task, the policy for the task is represented by a machine learning model, e.g., a neural network or other type of machine learning model having a plurality of weights. Thus, because the transition history sequence includes transitions for different time points during the training of this machine learning model and because the values of the weights are repeatedly updated during the training, the training history sequence for any given task will include transitions generated while the agent for the task was being controlled in accordance with multiple different sets of weight values for the plurality of weights.

Thus, any given training history sequence will reflect the agent for the task being controlled using a policy at different stages of training and may, e.g., start off with transitions generated as a result of controlling the agent with a random or close-to-random policy and then include subsequent transitions that reflect improvements in the quality of actions selected as training progresses.

In some implementations, the same reinforcement learning algorithm was used to train the policy for all of the tasks. For example, each policy can have been trained using a UCB (upper confidence bound) exploration technique, an on-policy reinforcement learning technique, e.g., on-policy actor-critic, an off-policy reinforcement learning technique, e.g., off-policy DQN, or any other appropriate reinforcement learning technique. Thus, the resulting training causes the action selection neural network to “distill” or “approximate” the reinforcement learning algorithm. In particular, training can cause the action selection neural network to implement a more computationally-efficient version of the algorithm after training, i.e., that requires performing fewer task episodes to achieve or exceed the final performance of the trained policy trained using the algorithm.

In some other implementations, different reinforcement learning algorithms can have been used to train the respective policies for different ones of the tasks.

That is, the training history sequences will include both (i) a first training history sequence that includes a sequence of tokens that represents transitions from a plurality of task episodes that were performed while training a policy for a first task through reinforcement learning using a first reinforcement learning algorithm and (ii) a second training history sequence of the plurality of training history sequences that includes a sequence of tokens that represents transitions from a plurality of task episodes that were performed while training a policy for a second task through reinforcement learning using a second, different reinforcement learning algorithm. Thus, the resulting training of the action selection neural network causes the action selection neural network to generalize between multiple different reinforcement algorithms.

One example technique for generating training history sequence is described below with reference to FIG. 3.

The system then trains the action selection neural network on the training data set by repeatedly performing steps 204 and 206.

The system selects, from the training data set, a subsequence of a respective training history sequence (step 204).

Generally, the subsequence represents transitions from a plurality of the task episodes represented in the training history sequence. That is, the subsequence includes transition subsequences corresponding to transitions from multiple different episodes of the task that are represented in the training history sequence.

For example, the system can randomly sample a subsequence of fixed length, i.e., that includes a fixed number of transition subsequences, with the only constraint being that the subsequence include transitions subsequences from multiple episodes. When the fixed length exceeds the maximum number of time steps in an episode, this constraint is automatically satisfied and the system can sample transition subsequences having the fixed length at random. The fixed length can be determined, for example, based on the context size for the action selection neural network, where the context size is the maximum number of tokens in any given input sequence to the action selection neural network.

The system trains the action selection neural network to predict, for each transition in the subsequence, the one or more tokens representing the action in the transition conditioned on the tokens that precede the one or more tokens representing the action in the subsequence (step 206).

Any suitable objective function can be used. Merely as one example, the system can train the action selection neural network on a negative log likelihood loss function L that satisfies:

L(θ):=−Σₙ₌₁^{N},Σₜ₌₁^{T-1} log P_{θ}(A=αₜ⁽ⁿ⁾|hₜ₋₁⁽ⁿ⁾,oₜ⁽ⁿ⁾)

Thus, since the reinforcement learning policy improves throughout each history sequence, by predicting actions accurately, the action selection neural network learns to output an improved policy relative to the one seen in the context.

In some implementations, the system can make use of label smoothing during the training. The label smoothing can involve smoothing a target for prediction, e.g., the action in the transition, over other possible targets, e.g., the other possible actions.

In particular, as part of training on the negative log likelihood loss function above, the system can use label smoothing regularization, in which the system uses, as the target probability distribution for the time step, a smoothed distribution that assigns a probability of 1−α to the action in the transition and α/(k−1) to each other action in the set of actions, where k is the total number of actions in the set and a is a positive hyperparameter between zero and one.

FIG. 3 is a flow diagram of an example process 300 for generating a training history for a given task. For convenience, the process 300 will be described as being performed by a system of one or more computers located in one or more locations. For example, an action selection system, e.g., the action selection system 100 of FIG. 1, appropriately programmed in accordance with this specification, can perform the process 300.

The system trains a policy for the task, e.g., a machine learning model, through reinforcement learning (step 302).

As part of training the policy, the system repeatedly performs steps 304-310.

In particular, the system performs an episode of the task by controlling the agent for the task using the policy for the task to generate transitions (step 304) and stores the transitions in a replay memory (step 306). The system also samples one or more transitions from the replay memory (step 308) and trains the policy one the one or more sampled transitions (step 310) using the reinforcement learning algorithm

In some implementations, the algorithm is a single stream algorithm and steps 304-310 are all performed by the same set of one or more hardware devices.

In some other implementations, the algorithm is a distributed algorithm and steps 304 and 306 are performed by multiple actors (“actor computing units”), each of which are implemented on a different set of hardware devices while steps 308 and 310 are performed one or more learners (“learner computing units”) implemented on a different set of hardware devices. Generally, the multiple actors can perform episodes of the task in parallel with one another during the training, i.e., each actor can perform iterations of steps 304 and 306 in parallel relative to each other actor. Optionally, the one or more learners performs steps 308 and 310 asynchronously from the actors performing steps 304 and 306.

The system then generates the training history sequence for the task from the transitions generated as a result of performing the task (step 312).

When multiple actors perform task episodes when generating training data, the respective training history sequence for the task includes episode subsequences for one or more episodes performed by each of the multiple actors.

In some implementations, the system includes, in the training history sequence for the task, a respective subsequence for each of the episodes generated during the training.

In some other implementations, however, the system subsamples the episodes when generating the training history sequence. In particular, in the respective training history sequence for the task, the system includes only episode subsequences for every k-th episode of the task that was performed during the training, where k is an integer greater than one.

In some cases, rather than subsampling the episodes when generating the training history sequence, the system can instead obtain an original training history sequence for the task that includes a respective episode subsequence for each of a plurality of original task episodes that were performed during the training and then subsamples the original training history sequence by generating the respective history training sequence that includes only episode subsequences for every k-th original task episode in the original training history sequence, where k is an integer greater than one. For example, the original training history may have been generated by another training system.

In both of these cases, this subsampling can assist the action selection neural network to become more data-efficient after training when performing “in-context” reinforcement learning, e.g., because the actions election neural network can learn to “distill” a more aggressive reinforcement learning algorithm by virtue of sub-sampling.

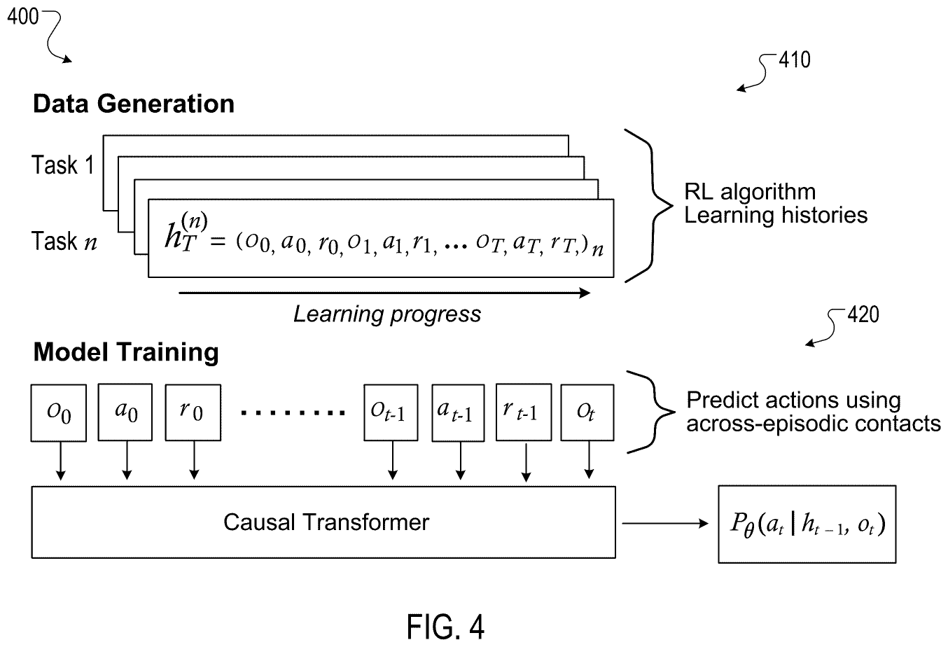

FIG. 4 is a diagram that shows an example 400 of the training of the action selection neural network 102.

In particular, in the example 400 the training includes a data generation phase 410 and a model training phase 420.

In the data generation phase 410, the system generates the training histories h_{T}⁽ⁿ⁾ for each of N tasks by training a respective policy for each task through reinforcement learning.

As shown in FIG. 4 and as described above, the training history for a given task includes data from transitions generated after different amounts of learning progress have occurred during the training of the policy for the task.

In the model training phase 420, the system trains the action selection neural network 120 (in the example of FIG. 4, a causal transformer neural network) to predict actions given the across-episodic contexts described above. That is, for a transition at time step t, the system trains the action selection neural network based on the probability P_{θ}(A=αₜ⁽ⁿ⁾|hₜ₋₁⁽ⁿ⁾,oₜ⁽ⁿ⁾).

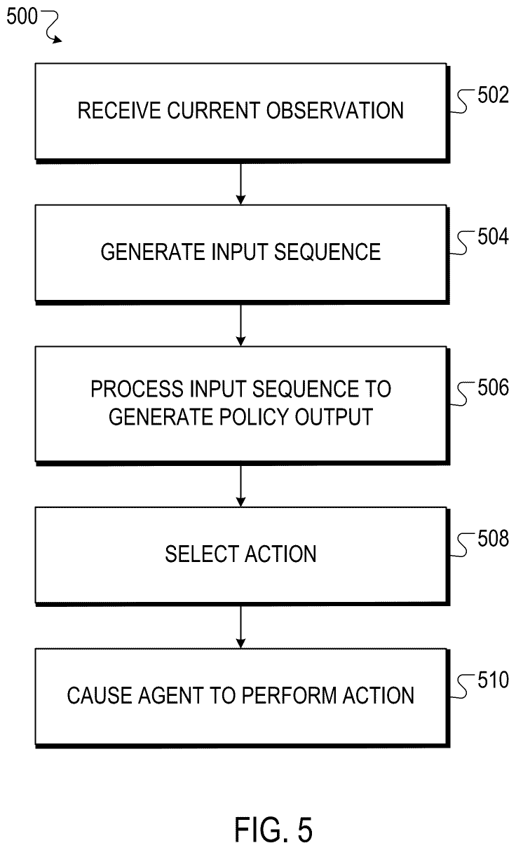

FIG. 5 is a flow diagram of an example process 500 for controlling an agent at a time step using the action selection neural network. For convenience, the process 500 will be described as being performed by a system of one or more computers located in one or more locations. For example, an action selection system, e.g., the action selection system 100 of FIG. 1, appropriately programmed in accordance with this specification, can perform the process 500.

The system can perform the process 200 at each time step during a sequence of time steps, e.g., at each time step during a task episode.

The system can also continue performing the process across different task episodes of the same task in order to perform “in-context” reinforcement learning of the task as described above.

That is, the system can repeatedly perform the process 500 to perform a sequence of task episodes of the task and to, during the task episodes, “in-context” reinforcement learn how to perform the task.

The system receives a current observation characterizing a state of the environment at the time step (step 502).

The system generates an input sequence of tokens (step 504). The input sequence of tokens includes (i) one or more tokens representing the current observation, (ii) a respective current transition subsequence for each of one or more current episode transitions, and (iii) a respective previous transition subsequence for each of one or more previous episode transitions.

Each current episode transition corresponds to a respective earlier time step in the current task episode and the respective transition subsequence for the current episode transition includes (a) one or more tokens representing an observation received at the earlier time step, (b) one or more tokens representing an action that was performed by the agent in response to the observation received at the earlier time step, and (c) one or more tokens representing a reward that was received in response to the agent performing the action.

Each previous episode transition corresponds to a respective earlier time step in a respective previous task episode that was performed by the agent prior to the current task episode, i.e., corresponds to a different task episode from the current task episode being performed, and the respective previous transition subsequence for the previous episode transition includes (a) one or more tokens representing an observation received at the earlier time step, (b) one or more tokens representing an action that was performed by the agent in response to the observation received at the earlier time step, and (c) one or more tokens representing a reward that was received in response to the agent performing the action.

Thus, the input sequence includes subsequences for transitions from multiple different episodes, i.e., the current episode and at least one earlier episode.

For example, the system can include, in the input sequence, a respective subsequence for up to a maximum number of most-recently generated transitions, e.g., with the maximum number being determined based on the context size for the action neural network. If more than the maximum number of transitions have been generated for the current task, the system selects the most-recently generated transitions to be represented in the input sequence.

In some implementations, if fewer than the maximum number of transitions have been generated, and the system has access to external data, e.g., from an expert policy for the task, the system can “prompt” the action selection neural network with the external data by including in the input sequence subsequences representing transitions from the expert data in addition to the subsequences from history data generated as a result of agent control using the action selection neural network.

The system processes the input sequence of tokens using the action selection neural network to generate a policy output for the time step (step 506) and selects an action using the policy output (step 508).

The system then causes the agent to perform the selected action (step 510).

Generally, the agent is controlled whilst holding values of the parameters of the action selection neural network fixed to their trained values, e.g., determined by training the action selection neural network as described above.

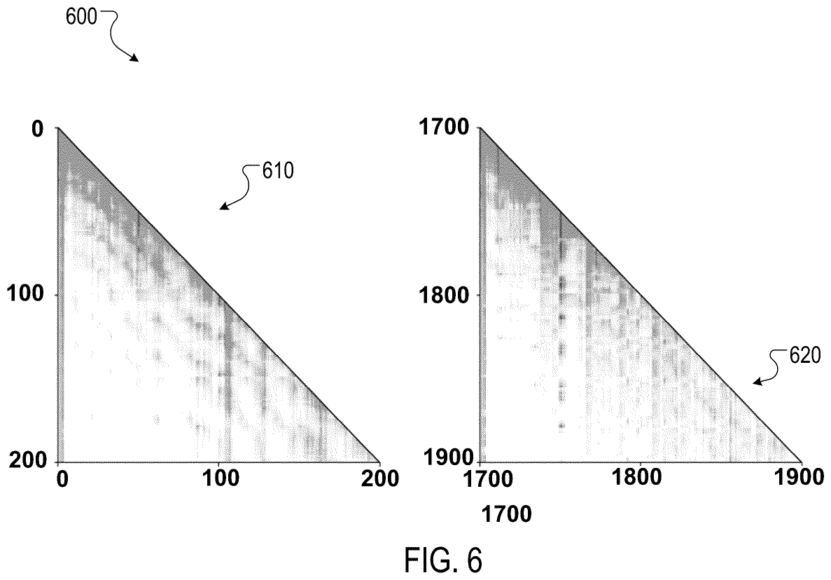

FIG. 6 shows an example 600 of attention maps generated by the action selection neural network across time steps when controlling the agent for a new task. In the example of FIG. 6, each episode is 50 steps, the maximum size is transitions from 200 time steps, the left column 610 shows attention maps from steps 0 to 200 and the right column 620 shows attention maps from steps 1700 to 1900. White and gray colors correspond to low and high attention, respectively. From these patterns, it is evident that the action selection neural network attends to tokens across several episodes to predict its next action.

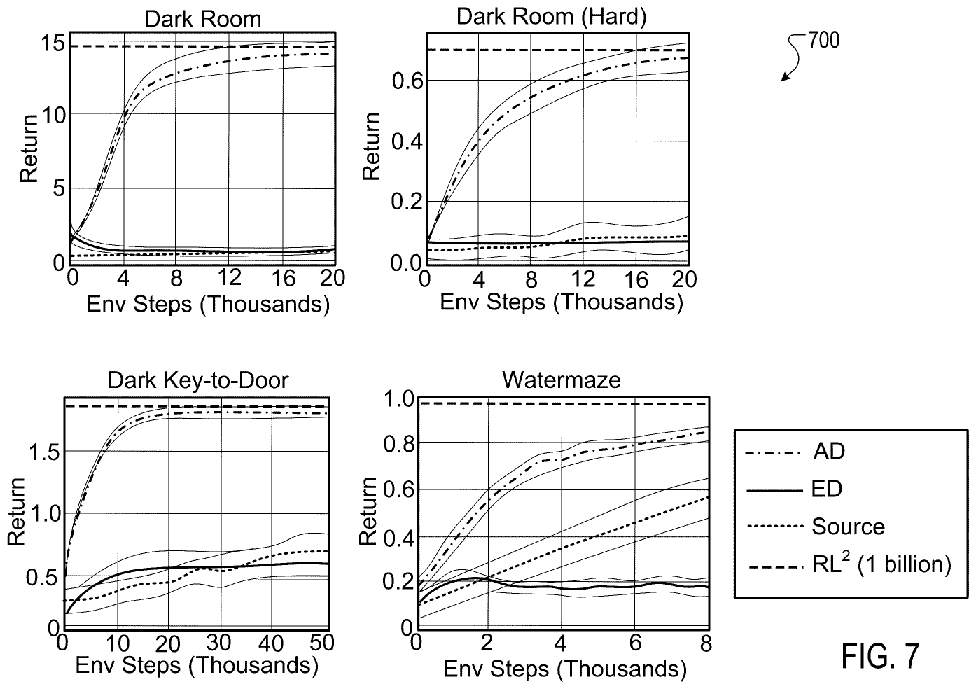

FIG. 7 shows an example of the results achieved by the described techniques (“AD”) relative to two baselines (“ED” and “source”) on four different tasks. As can be seen from FIG. 7, AD consistently in-context reinforcement learns all four tasks effectively while being more data-efficient than any of the baselines. FIG. 7 also shows, as an upper bound on the performance of AD, asymptotic performance of an online-RL algorithm (“RL²”) which interacts with the environment both during training and during acting.

In particular, in the example of FIG. 7, one of the two baselines is the source RL (“source”) algorithm used to generate the training data for the neural network used in the AD techniques. As can be seen from FIG. 7, the described techniques result in a policy that learns the task more effectively while being significantly more data-efficient than the source RL algorithm.

One of the other two baselines (“ED”) is an expert distillation technique that uses the same action selection neural network as AD but trained only on “expert” trajectories rather than learning histories. As can be seen from the figure, AD significantly outperforms ED, e.g., because AD uses learning histories during training instead of simply high-performing expert trajectories.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a sub combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method performed by one or more computers, the method comprising:
obtaining a training data set that comprises a respective training history sequence for each of a plurality of tasks, wherein:
each training history sequence comprises a sequence of tokens that represents transitions from a plurality of task episodes that were performed while training a policy for the task through reinforcement learning,
the sequence of tokens comprises a respective episode subsequence for each of the plurality of task episodes, and
the respective episode subsequence for each of the task episodes comprises, for each transition from the task episode, a respective transition subsequence that comprises:
(i) one or more tokens representing an observation in the transition,
(ii) one or more tokens representing an action in the transition, and
(iii) one or more tokens representing a reward in the transition; and
training an action selection neural network on the training data set, the training comprising, at each of a plurality of training steps:
selecting, from the training data set, a subsequence of a respective training history sequence from the training data set, the subsequence representing transitions from a plurality of the task episodes represented in the training history sequence; and
training the action selection neural network to predict, for each transition in the subsequence, the one or more tokens representing the action in the transition conditioned on the tokens that precede the one or more tokens representing the action in the subsequence.

2. The method of claim 1, wherein, within each training history sequence, the episode subsequences are ordered according to an order in which the corresponding task episodes were performed during the training.

3. The method of claim 1, wherein each training history sequence comprises transitions generated while an agent for the task was being controlled by the policy for the task at multiple different time points during the training of the policy.

4. The method of claim 3, wherein the policy for the task is represented by a machine learning model having a plurality of weights and wherein the training history sequence comprises transitions generated while the agent for the task was being controlled in accordance with multiple different sets of weight values for the plurality of weights.

5. The method of claim 1, wherein:
a first training history sequence of the plurality of training history sequences comprises a sequence of tokens that represents transitions from a plurality of task episodes that were performed while training a policy for a first task through reinforcement learning using a first reinforcement learning algorithm; and
a second training history sequence of the plurality of training history sequences comprises a sequence of tokens that represents transitions from a plurality of task episodes that were performed while training a policy for a second task through reinforcement learning using a second, different reinforcement learning algorithm.

6. The method of claim 1, wherein obtaining a training data set that comprises a respective training history sequence for each of a plurality of tasks comprises, for each of one or more of the tasks:
training the policy for the task through reinforcement learning, the training comprising repeatedly performing the following operations:
performing an episode of the task by controlling an agent for the task using the policy for the task to generate transitions;
storing the transitions in a replay memory;
sampling one or more transitions from the replay memory; and
training the policy on the one or more sampled transitions.

7. The method of claim 6, wherein obtaining a training data set that comprises a respective training history sequence for each of a plurality of tasks further comprises, for each of the one or more tasks:
including, in the respective training history sequence for the task, only episode subsequences for every k-th episode of the task that was performed during the training, wherein k is an integer greater than one.

8. The method of claim 6, wherein repeatedly performing the following operations comprises:
performing multiple episodes of the task in parallel using multiple actor computing units, and wherein
the respective training history sequence for the task includes episode subsequences for one or more episodes performed by each of the multiple actors.

9. The method of claim 1, wherein obtaining a training data set that comprises a respective training history sequence for each of a plurality of tasks, comprises, for each of one or more of the tasks:
obtaining an original training history sequence for the task that comprises a respective episode subsequence for each of a plurality of original task episodes that were performed during the training; and
generating the respective history training sequence that includes only episode subsequences for every k-th original task episode in the original training history sequence, wherein k is an integer greater than one.

10. The method of claim 1, wherein, at one or more of the plurality of training steps:
training the action selection neural network to predict, for each transition in the subsequence, the one or more tokens representing the action in the transition conditioned on the tokens that precede the one or more tokens representing the action in the subsequence comprises:
training the action selection neural network with label smoothing.

11. A method performed by one or more computers for controlling an agent to perform a sequence of task episodes of a task, the method comprising, for each of a plurality of time steps in a sequence of time steps in a current task episode:
receiving a current observation characterizing a state of the environment at the time step;
generating an input sequence of tokens that comprises:
(i) one or more tokens representing the current observation,
(ii) a respective current transition subsequence for each of one or more current episode transitions, each current episode transition corresponding to a respective earlier time step in the current task episode and the respective transition subsequence for the current episode transition including (a) one or more tokens representing an observation received at the earlier time step, (b) one or more tokens representing an action that was performed by the agent in response to the observation received at the earlier time step, and (c) one or more tokens representing a reward that was received in response to the agent performing the action, and
(iii) a respective previous transition subsequence for each of one or more previous episode transitions, each previous episode transition corresponding to a respective earlier time step in a respective previous task episode that was performed by the agent prior to the current task episode and the respective previous transition subsequence for the previous episode transition including (a) one or more tokens representing an observation received at the earlier time step, (b) one or more tokens representing an action that was performed by the agent in response to the observation received at the earlier time step, and (c) one or more tokens representing a reward that was received in response to the agent performing the action;
processing the input sequence of tokens using the action selection neural network to generate a policy output for the time step;
selecting an action using the policy output; and
causing the agent to perform the selected action.

12. The method of claim 11, wherein controlling an agent to perform a sequence of task episodes of a task comprises controlling the agent while holding values of the parameters of the action selection neural network fixed to trained values determined by training the action selection neural network.

13. The method of claim 11, wherein the action selection neural network is a causal Transformer neural network.

14. The method of claim 11, wherein the action selection neural network is a recurrent neural network.

15. The method of claim 11, wherein the input sequence comprises the previous transition subsequences followed by the current transition subsequences and followed by the one or more tokens representing the current observations, and wherein the previous transition subsequences and the current transition subsequences are ordered within the input sequence according to an order in which the corresponding transitions were generated.

16. The method of claim 11, wherein the agent is a mechanical agent interacting with a real-world environment.

17. The method of claim 16, wherein the mechanical agent is a robot.

18. A system comprising:
one or more computers; and
one or more storage devices communicatively coupled to the one or more computers, wherein the one or more storage devices store instructions that, when executed by the one or more computers, cause the one or more computers to perform operations comprising:
obtaining a training data set that comprises a respective training history sequence for each of a plurality of tasks, wherein:
each training history sequence comprises a sequence of tokens that represents transitions from a plurality of task episodes that were performed while training a policy for the task through reinforcement learning,
the sequence of tokens comprises a respective episode subsequence for each of the plurality of task episodes, and
the respective episode subsequence for each of the task episodes comprises, for each transition from the task episode, a respective transition subsequence that comprises:
(i) one or more tokens representing an observation in the transition,
(ii) one or more tokens representing an action in the transition, and
(iii) one or more tokens representing a reward in the transition; and
training an action selection neural network on the training data set, the training comprising, at each of a plurality of training steps:
selecting, from the training data set, a subsequence of a respective training history sequence from the training data set, the subsequence representing transitions from a plurality of the task episodes represented in the training history sequence; and
training the action selection neural network to predict, for each transition in the subsequence, the one or more tokens representing the action in the transition conditioned on the tokens that precede the one or more tokens representing the action in the subsequence.

19. The system of claim 18, wherein, within each training history sequence, the episode subsequences are ordered according to an order in which the corresponding task episodes were performed during the training.

20. The system of claim 18, wherein each training history sequence comprises transitions generated while an agent for the task was being controlled by the policy for the task at multiple different time points during the training of the policy.
